(19) United States
(12) Patent Application Publication
(10) Pub. No.: US 2012/0016897 A1
(43) Pub. Date: Jan. 19, 2012

(54) SYSTEM AND METHOD FOR IMPROVING WEBPAGE INDEXING AND OPTIMIZATION

(75) Inventors: Gregory TULUMBAS, Long Beach, NY (US); Hamlet Batista Reyes, Old Bridge, NJ (US)

(73) Assignee: ALTRUIK, INC., New York, NY (US)

(21) Appl. No.: 13/184,245

(22) Filed: Jul. 15, 2011

Related U.S. Application Data
(60) Provisional application No. 61/365,089, filed on Jul. 16, 2010.

(51) Int. Cl. G06F 17/30

(52) U.S. Cl. 707/759; 707/E17.069

(57) ABSTRACT

A system and method may include a processor that normalizes dynamic URLs by sorting URL parameters and removing duplicative URL parameters. The processor may additionally or alternatively provide redirects from one URL to another, where the two URLs are associated with duplicative content. The processor may additionally or alternatively insert a canonical tag into content associated with a URL, where the canonical tag points to another URL whose content is a near duplicate of the content associated with the first URL. The processor may additionally or alternatively apply transformation rules to content of a webpage based on the matching of portions of the URL of the webpage to various character strings.

### CROSS-REFERENCE TO RELATED APPLICATION

This application claims the benefit, under 35 U.S.C. §119(e), of U.S. Provisional Patent Application No. 61/365,089 filed Jul. 16, 2010, the entire contents of which is hereby incorporated by reference in its entirety.

### FIELD OF THE INVENTION

The present invention relates to a system and method for automatically identifying duplicative webpage information, optimizing webpages, and improving webpage indexing.

### BACKGROUND

A single webpage or similar webpages, for example a single dynamic webpage or similar dynamic webpages, are currently accessible via selection of multiple URLs, which is a barrier to webpage indexation. Additionally, webpages often lack features which provide for optimal indexation and ranking of the webpages.

### SUMMARY

Example embodiments of the present invention provide an Overlay Search Engine Optimization (SEO) system that may provide search engine optimized “overlay pages” of a customer's native web site, where the customer refers to a web server. The SEO system may intercept a data request and a response thereto in order to optimize pages, as illustrated in FIG. 1.

For the interception, the SEO system may act as a reverse proxy system, where the DNS of the web server points to the SEO system. Alternatively, the SEO system may act as an intelligent web cache, and requests directed towards the web server may be forwarded to the SEO system by a network device, such as a router or switch. For example, the Web Cache Communication Protocol may be used for this purpose.

Example embodiments of the present invention provide a number of methods for reducing the number of pages served from the native web site containing duplicate content, which duplication of content may be a barrier to indexation by search engine robots (bots).

Processing to address duplicative webpages or URLs directed to a same or similar page may be performed, for example, at the edge of the web server network, rather than, for example, during web crawling.

According to example embodiments of the present invention, the system manipulates the underlying HTML of the native website to provide output that conforms with SEO best practices.

### BRIEF DESCRIPTION OF THE DRAWINGS

FIG. 1 illustrates a dataflow according to example embodiments of the present invention.

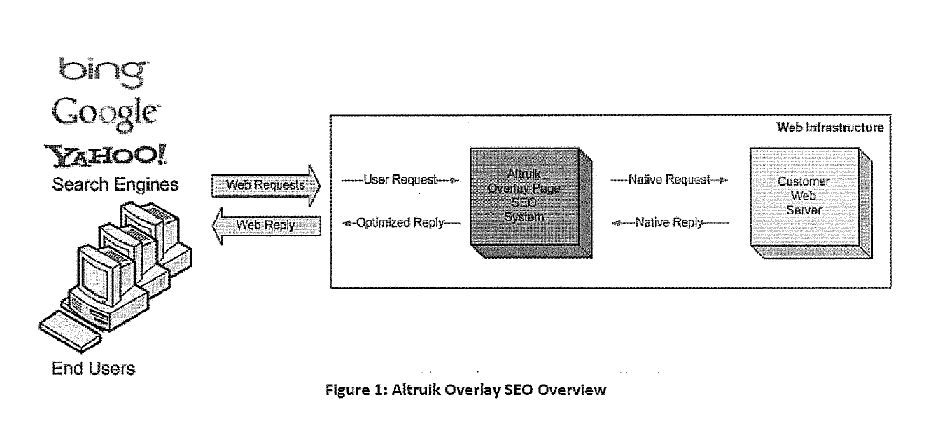

FIG. 2 illustrates a dataflow for a URL redirect for exact duplicates, according to an example embodiment of the present invention.

FIG. 3 illustrates a dataflow for a canonical tag insertion for near duplicates, according to an example embodiment of the present invention.

FIG. 4 illustrates a dataflow for content pass-through, according to an example embodiment of the present invention.

FIG. 5 illustrates a dataflow for applying optimization transformations, according to an example embodiment of the present invention.

FIG. 6 illustrates a reverse proxy deployment infrastructure, according to an example embodiment of the present invention.

FIG. 7 illustrates a web farm deployment infrastructure, according to an example embodiment of the present invention.

FIG. 8 illustrates a server plug-in deployment infrastructure, according to an example embodiment of the present invention.

### DETAILED DESCRIPTION

Example embodiments of the present invention provide features that 1) address barriers to indexation, which barriers are, for example, caused by duplicate content, duplicate content referring to a single content associated with multiple URLs; and 2) increase search result ranking, e.g., by use of canonical tags for similar pages, and/or by page optimization.

Normalization

Example embodiments of the present invention provide a number of methods for reducing the number of pages served from the native web site containing duplicate content, which duplication of content may be a barrier to indexation by search engine robots (bots).

In an example embodiment of the present invention, for duplicate URL removal, the system may perform a process to “normalize” dynamic URLs through which content is accessed on the native web site, where a dynamic URL refers to a URL in response to which the web server dynamically generates a webpage for serving in response to the request. The dynamic URL includes query parameters, i.e., values, for example, included after respective question marks, used by the web server to determine which content to serve in the dynamic webpage. The specific variables are application dependent. Without the normalization, multiple versions of a URL may be used to access the same webpage. For example, different versions may include the same parameters in different orders, and some URLs may include duplicates of a single parameter.

For the normalization, the SEO system may view incoming requests and may: 1) sort query parameters, e.g., the alphanumeric key values, of the URLs; 2) check for, e.g., by comparison of the sorted parameters, and remove from memory, duplicate ones of the sorted parameters, where a parameter is a duplicate if it corresponds to the same webpage key and value pair of another parameter; and 3) convert the remaining dynamic URLs into static URLs. Thus, where a URL is a duplicate of another URL, a single static version of the URL would be provided. The conversion to a static version may be advantageous for search engines that favor static URLs over dynamic URLs. In an alternative example embodiment, conversion to a static URL may be omitted. Instead, parameters may be sorted and duplicate parameters may be removed, to produce the URL to be used.

An example of a dynamic URL that includes alphanumeric key values to be normalized is “http://www.example.com/category/tshirts?sort_by=price&size=large,” where “sort_by” and “size” are keys and “price” and “large” are their respective values. An example of such a dynamic URL that includes duplicative query parameters is “http://www.example.com/category/tshirts?sort_by=price&size=large&sort_by=price.”

Once this is accomplished via the internal algorithm, the SEO system sends a redirect, e.g., a 301 redirect, back to the end-user web browser with the new, normalized URL to access the content, e.g., static according to the first embodiment described in the immediately preceding paragraph or dynamic according to the alternative embodiment described in the immediately preceding paragraph. The web browser then requests the normalized URL from the native web server. The system intercepts the request for the normalized URL and converts the normalized URL back into a dynamic URL that the native web server understands.

The following are steps of an example in which normalization is performed:

a. a web browser requests:
http://www.example.com/directory?variable3=3&variable1=1&variable2=2&variable1=1;

b. the SEO system converts the URL into:
http://www.example.com/directory/seo/variable1_{—}1/variable2_{—}2/variable3_{—}3;

c. the SEO system sends the new URL back to the web browser as a 301 redirect, indicating that the resource has moved permanently;

d. the web browser responsively requests the new URL;

e. the SEO system converts the new URL back into:
http://www.example.com/directory?variable1=1&variable2=2&variable3=3; and

f. the SEO system passes the converted URL to the native web server, obtains the webpage content from the web server, and passes it to the web browser.

As a result of this normalization, web sites programmed to have an architecture that handles multiple versions of a single query, where the different versions differ, for example, with respect to parameter order, and/or that allows for a query to include duplicates of a single parameter, are effectively modified to ensure that web browsers and search engine bots record only a single working URL according to a single permutation of the query parameters for a single piece of content on the native web site.

It is noted that, even after normalization, the same parameters may be included in multiple URLs, where different ones of the multiple URLs include different combinations of the parameters. For example, a first normalized URL may include parameters A and B, while a second normalized URL may include parameters A and C.

Ultimately, because of the URL normalization, each served webpage is associated by a bot with a single URL, e.g., static or dynamic depending on implementation. For example, the web crawler may grab pages on the website, and be redirected to the normalized URLs, which the web crawler may index.

Rewrite of On-Page Links for Normalization

It may occur that a website server serves a page that includes non-normalized links to other webpages. Should such a link be selected by a user or traversed by a web crawler bot, the system may perform the method described above for normalizing the webpage request.

However, in an example embodiment of the present invention, where a website server serves a page via the normalization system, the system may, upon receipt of the webpage from the server, normalize the links, e.g., according to the method described above, modify the webpage to include the normalized links, and serve the modified webpage to the requesting entity. Accordingly, when a webpage request is later transmitted by selection of the normalized link of the modified webpage, a redirect would not be necessary.

Automatic Duplicate Content Correction

Aside from content associated with multiple URLs that differ in parameter order and/or duplication, significant duplicative content may be served in different webpages. For example, a website may categorize certain content under multiple categories, so that the same content may be accessed in various ways when browsing a website. For example, information about a certain product may be provided in a first webpage under the category of “men's apparel” and under the category “pants.”

In an example embodiment of the present invention, the SEO system may identify such duplicative content and set a single one of the webpages as authoritative. Duplicate content may be eliminated by assigning an “authoritative” URL for each piece of content on the web site.

In an example embodiment, the SEO system may compare webpages to address two types of duplicate content, including: 1) exact duplicate content in the HTML body; and 2) near-duplicate content in the HTML body.

To identify exact duplicates, the SEO system may compute a “digital fingerprint” for a currently requested page, e.g., the fingerprint may be computer based on all of the HTML document corresponding to the visible content with respect to the web browser. The calculation may be performed responsive to requests because the web servers may provide dynamically generated webpages in response to the requests. The digital fingerprint may be a checksum. The digital fingerprint will match the digital fingerprint of any exact duplicate content. An example algorithm which may be used for computing the digital fingerprint is CRC32, described at http://en.wikipedia.org/wiki/Cyclic_redundancy_check.

This fingerprint is computed and stored for any page that is requested through the

SEO system, for later comparisons. The SEO system may store the checksums in a file-based database on the SEO system. For example, the SEO system stores a table that associates each computed checksum value with the URL for which it was computed.

When a number of exact duplicates for a single piece of content are stored, an algorithm to decide on an authoritative URL is executed and, by use of URL redirection, that becomes the only URL through which it is possible to access that content. The following is a non-exhaustive list of example methods, one or more of which may be used by the algorithm to select the authoritative URL by: 1) shortest URL; 2) most accessed URL, with a threshold by count or percentage; and 3) a user-based selection via an administration interface.

Where the second method is used, the system may continue to allow access to the content via multiple URLs, until the threshold is met.

Combinations of the above methods may also be used. For example, different weights may be given to a URL based on its size and based on the number of times it has been accessed, e.g., relative to other URLs. Further, the system may, in an example, suggest one of the URLs as authoritative, which must then be confirmed by a user via the administration interface.

Once an authoritative URL is selected, any subsequent requests for an exact copy of the content through an alternate URL are 301 redirected, e.g., as described above with respect to URL normalization.

Based on the algorithms for determining an authoritative URL, the URL which the system determines to be authoritative may change over time. Accordingly, while redirection may at first be from a first URL to a second URL, the redirection may subsequently be to the first URL or to a third URL.

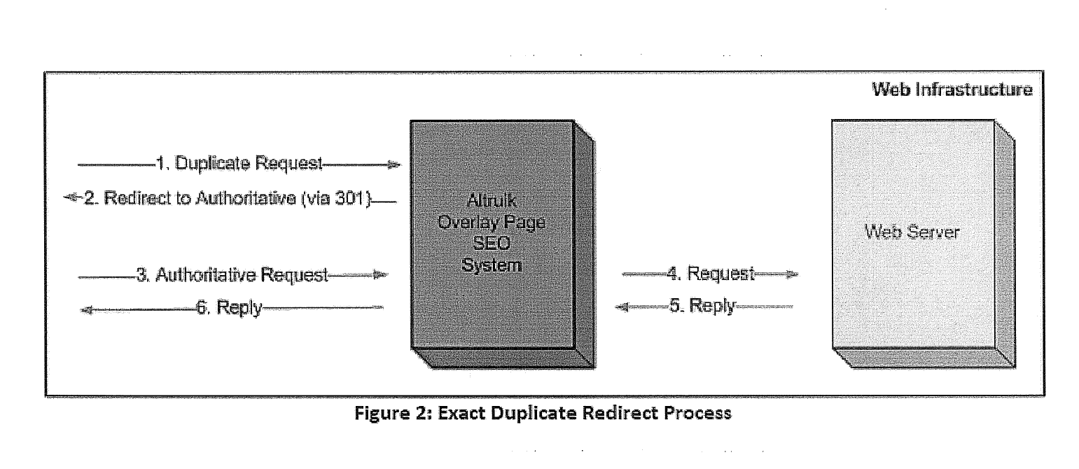

FIG. 2 illustrates an example dataflow for URL processing for duplicate webpages.

In an example embodiment of the present invention, for near-duplicate detection, the SEO system may execute an algorithm for producing digital fingerprints, such that similar fingerprints are produced for similar content. The SEO system may then approximate the difference between two pieces of content by the difference in the fingerprints.

For example, a simhash algorithm (developed by Moses Charikar) may be used. A simhash is calculated for the HTML content of a requested page and this fingerprint is compared to the simhash the system previously computed for previously processed content to determine if there is a near-duplicate. Additionally, the simhash fingerprint is stored for later comparisons. For example, even after the SEO system determines that the current page is a near duplicate of another page which other page is determined to be authoritative, the calculated simhashes of each page may be stored for comparison of each to later calculated simhashes.

The system may, for example, calculate a hamming distance based on the two simhash values. The hamming distance may represent the degree of similarlity. The system may consider a hamming distance meeting a predetermined threshold as indicating that the compared content is similar to the extent that they should be merged by the search engine via canonical tags to an authoritative one of the URLs.

The simhash algorithm is better suited than the checksum algorithm for determining near duplicates because the checksum algorithm produces completely different values even for similar content.

In an example embodiment of the present invention, the SEO system may optimize the algorithm for determining near duplicates, to reduce the number of required comparisons for the check. For example, as pages are processed, the data store of simhash values, to which a simhash value of a subsequently processed page are to be compared, may continue to grow. The optimization may reduce the number of prior simhash values to which a newly computed simhash value is compared. The optimization may be realized, for example, via bit rotation and sorting, by which each simhash value need not be compared to every other one of the simhash values.

Once the near-duplicates are identified and grouped, the near-duplicate authoritative URL is selected via one or more of the metrics mentioned above for the exact duplicates.

In order to consolidate page rank to the authoritative URL, a “canonical tag” is inserted into the HTML header of the non-authoritative pages in real-time, i.e., when the page is provided to the web browser. This canonical tag suggests to the search engine bots that the page contains duplicate content and provides a pointer to the authoritative URL. Thus, while near duplicative pages may each continue to be provided to the requesting web browser, the canonical tag may be used for consolidation with respect to rank and/or for suggesting a webpage in response to a search query. Even after determining that pages are nearly duplicative, the system may continue to allow requests for the non-authoritative page to pass through for processing by the web server, unlike that which was described above with respect to exact duplicates, in which case there is redirection. On the other hand, in the case of exact duplicates, the redirect may be used, as described above, instead of a canonical tag, because this may result in a higher page ranking of the authoritative page than if a canonical tag was used, and/or because use of a redirect increases efficiency for search engines and bots which would therefore not request and obtain multiple copies of the same content. For example, a single cached copy may be referenced by a search engine, and a single version would be obtained and indexed by the bot.

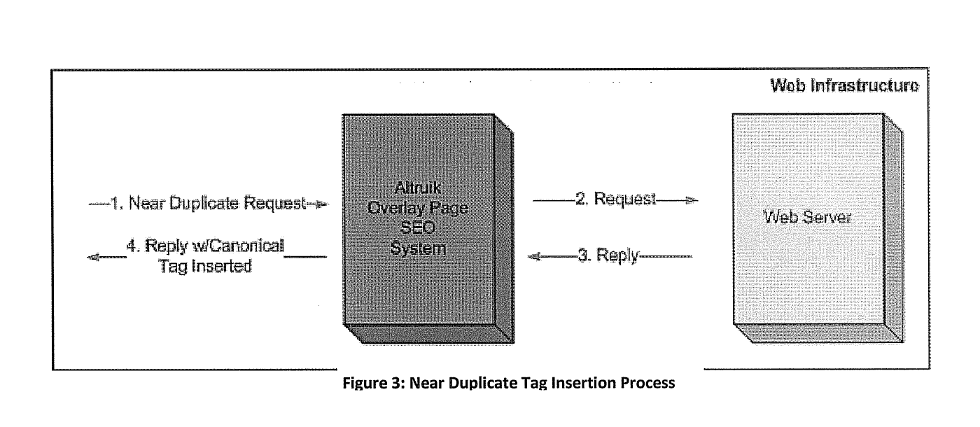

FIG. 3 illustrates an example dataflow for processing near duplicate webpages.

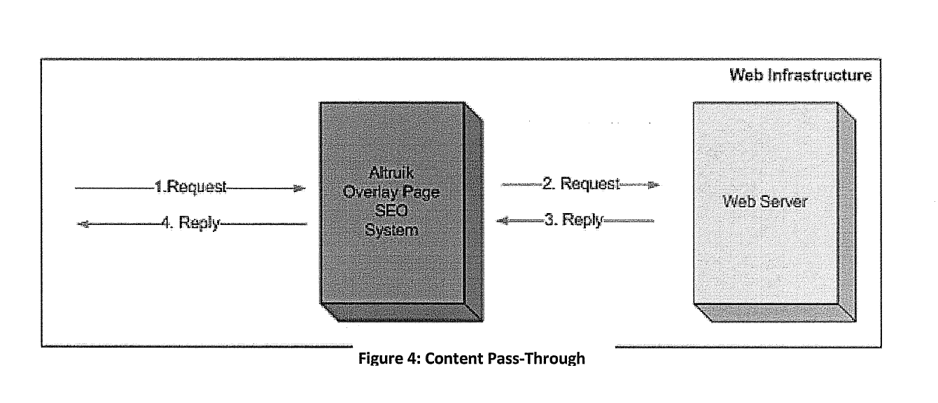

Any content that is not flagged as duplicate and, therefore, does not require processing by the automatic duplicate content correction system is passed through this portion of the system unchanged to the web browser. FIG. 4 illustrates an example dataflow for content pass-through.

Rewrite of On-Page Links for Reference to Authoritative Links

It may occur that a website server serves a page that includes links to other non-authoritative webpages that are exact duplicates of webpages designated as authoritative. Should such a link be selected by a user or traversed by a web crawler bot, the system may perform the method described above for redirecting the requesting entity to the authoritative webpage.

However, in an example embodiment of the present invention, where a website server serves a webpage via the SEO system, the system may, upon receipt of the webpage from the server, modify the webpage to include the links to the authoritative exact duplicate webpage, and serve the modified webpage to the requesting entity. Accordingly, when a webpage request is later transmitted by selection of the substitute link of the modified webpage, a redirect would not be necessary.

For example, as pages are served via the SEO system, the SEO system may compare the, e.g., checksum, values associated with the pages for selection of one of the URLs of duplicate content as authoritative. The system may record the selection of the authoritative URL. Subsequently, when the server serves a page including a link to one of the non-authoritative ones of the pages, the system may look-up its store of duplicate content and selection of the authoritative URL, and replace the link with the authoritative URL.

SEO Page Optimization

In order to provide the best page possible to the search engine bot, various SEO transformations may be applied to the HTML content of the native page. Some examples of these types of changes are modifying page titles, changing meta description tags, and inserting H1 tags.

The system provides rules for modifying page content in real-time based on a pre-defined set of rules. These transformation rules can be grouped and applied to webpages based on specific sections of the native site to which the webpages correspond (e.g., “Product Ruleset” may be applied to pages whose URLs include “/Products/*”), where * represents a wildcard character that will match anything that follows. The rules are configurable through an administration interface and can be introduced into the running system gradually, if necessary.

The technology architecture allows an arbitrary number of rules to be applied in a configurable manner.

The SEO system may perform the following in real-time for the optimization: 1) group URLs, e.g., based on expressions and/or parameters within the URLs, such as “Products/*” or “product/=,” in order to retrieve a list of transformation rules to apply; 2) obtain data from the native page for later use in transformation rules; 3) process the outbound HTML of the native page to incorporate the changes; and 4) return the updated page to the web browser.

For example, in accordance with the grouping, the SEO system may determine which data to obtain from the native web site in for modification of the webpage by application of a transformation rule. For example, a rule, when executed, may cause a processor to identify a product name and brand from a specified section of a product page. The rule may, for example, cause the processor to modify the title of the page using the obtained data. Other transformations are also possible.

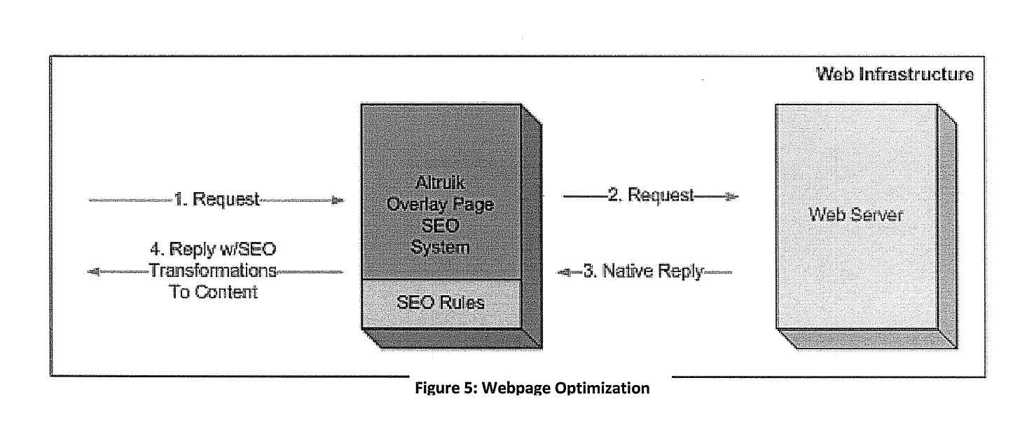

FIG. 5 illustrates an example dataflow for applying optimization transformations.

Deployment

In order to perform the required native page interception, there are various deployment options for the SEO system. Example options include: reverse proxy, web farm, and server plug-in.

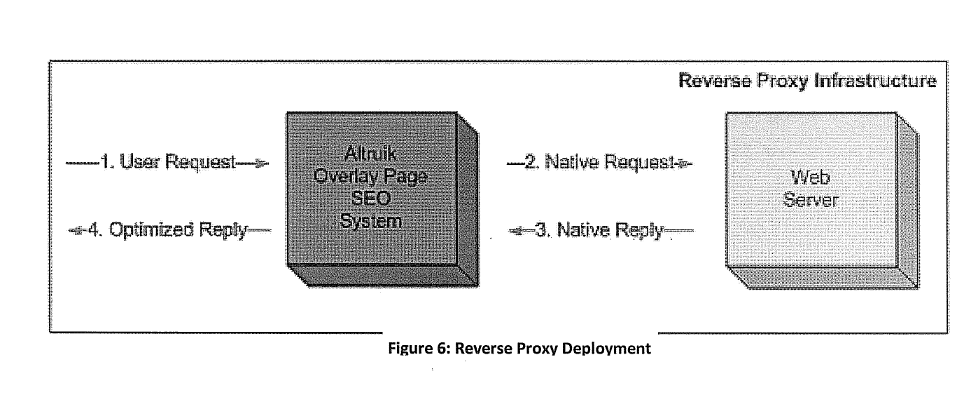

A reverse proxy deployment is one in which the SEO system sits within the network data stream of the web server, where, for example the DNS of the web server points to the SEO system. The SEO system would see all internet traffic requests destined for the web server and perform the described native page transformations and/or redirections. FIG. 6 illustrates an example reverse proxy deployment infrastructure.

For example, with respect to the normalization and redirect procedure, a user request or bot request would be directed initially to the SEO system. The SEO system would then redirect the requestor to the normalized URL. The SEO system would then receive the webpage request via the normalized URL. The SEO system would then forward the normalized request to the server, receive the webpage in response, and forward the webpage on to the requesting entity.

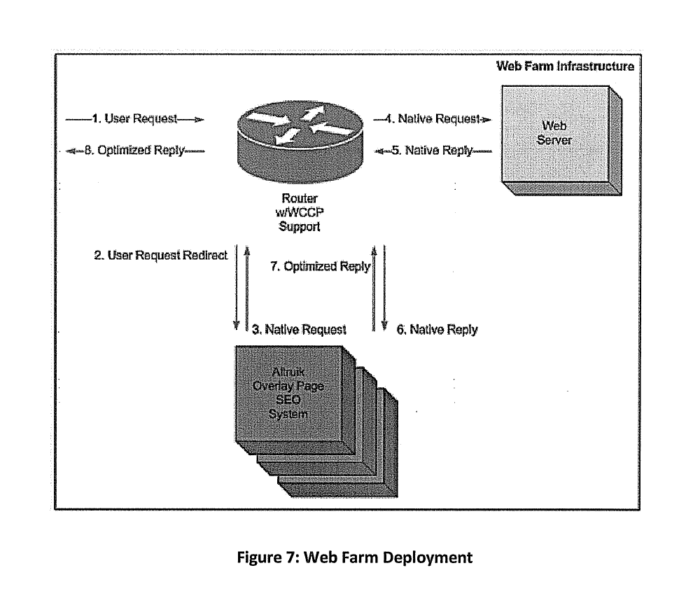

The web farm deployment option utilizes a network device feature such as created by CISCO to support web caching using the Web Cache Communication Protocol (WCCP). This feature allows the network device (such as a CISCO router or switch) to intercept a web request and forward it on to a group of out-of-band devices for processing. In this scenario, a number of SEO system processing units may handle the request in coordination with the native servers. FIG. 7 illustrates an example web farm deployment infrastructure.

For example, with respect to the normalization and redirect procedure, a user request or bot request would be directed initially to the router and from the router to the SEO system. The SEO system would then provide the redirect to the normalized URL to the router which would forward it on to the requestor. The router would then receive, and forward on to the SEO system, the webpage request via the normalized URL. The SEO system would then forward the normalized request to the router, which would forward the normalized request on to the server. In an example embodiment, the router would then receive the webpage in response from the server, forward the webpage on to the SEO system, which would then pass it back to the router for forwarding to the requesting entity.

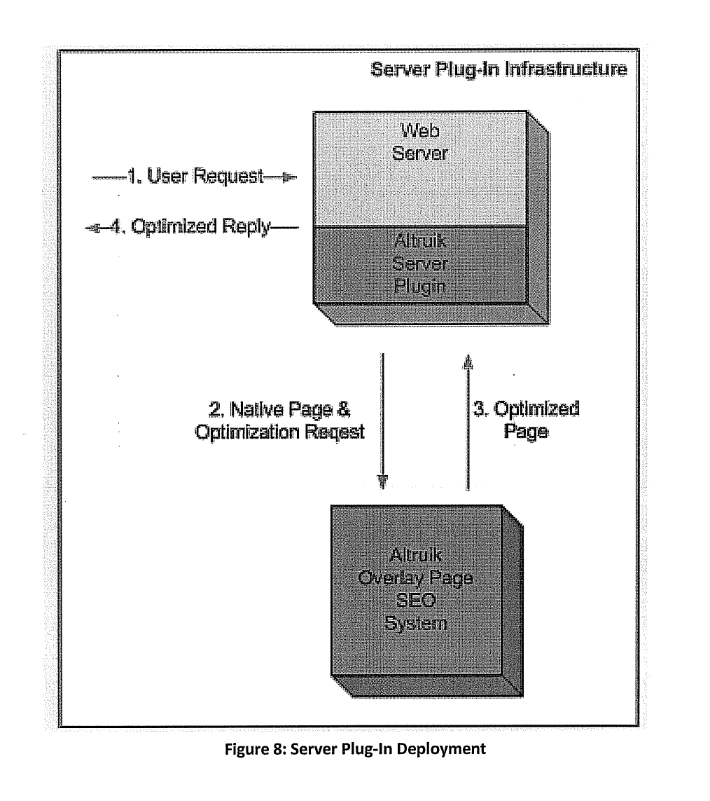

In a server plug-in deployment scenario, software is installed on the web servers in order to intercept the request to the native web server. Additionally, the reply from the native web server is redirected to the SEO system in order to apply the necessary SEO transformations. The page is then returned, e.g., by the plug-in software or the web server software, to the web browser. FIG. 8 illustrates an example server plug-in deployment infrastructure.

This deployment option differs from the reverse proxy deployment option in that, in the server plug-in deployment scenario software on the web server facilitates the interception, whereas in the reverse proxy deployment scenario, a network appliance sits upstream of the web server for the traffic interception. For example, with respect to the normalization and redirect procedure, such procedure may operate essentially as described above with respect to the reverse proxy deployment.

Additional Notes

An example embodiment of the present invention is directed to one or more processors, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors may be embodied in a server or user terminal or combination thereof. The user terminal al may be embodied, for example, as a desktop, laptop, hand-held device, Personal Digital Assistant (PDA), television set-top Internet appliance, mobile telephone, smart phone, etc., or as a combination of one or more thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

The described memory device may also be used for storing data obtained through the described processing methods, e.g., digital fingerprints, URLs, webpage content, etc.

An example embodiment of the present invention is directed to one or more hardware computer-readable media, e.g., as described above, having stored thereon instructions executable by a processor to perform the methods described herein.

An example embodiment of the present invention is directed to a method, e.g., of a hardware component or machine, of transmitting instructions executable by a processor to perform the methods described herein.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A computer-implemented page request normalization method, comprising:
responsive to receipt of a page request from a requesting entity, modifying, by a computer processor, the request by at least one of (a) removing one or more of duplicative parameters included in the request, and (b) changing an order of parameters of the request; and
returning, by the processor and to the requesting entity, the modified request as a page redirect.

2. The method of claim 1, wherein the requests are in the form of Uniform Resource Locator (URL).

3. The method of claim 2, wherein the URL of the received request refers to a dynamic webpage.

4. The method of claim 3, wherein the modifying includes sorting query parameters of the URL by one or more sort keys.

5. The method of claim 4, wherein the modifying further includes:
comparing pairs of the query of the query parameters to determine whether they are duplicates of each other; and
for each of the pairs of compared query parameters determined to be duplicates of each other, removing one of the parameters of the respective pair.

6. The method of claim 3, wherein the modifying includes sorting query parameters of the URL by alphanumeric order.

7. The method of claim 6, wherein the modifying further includes, subsequent to the sorting:
comparing pairs of the query of the query parameters to determine whether they are duplicates of each other; and
for each of the pairs of compared query parameters determined to be duplicates of each other, removing one of the parameters of the respective pair.

8. The method of claim 3, wherein each of at least one of the parameters of the URL of the received request includes a respective key and a respective value for the key.

9. A computer-implemented page request handling method, comprising:
where different ones of a plurality of received webpage requests differ with respect to at least one of (a) a number of included copies of a query parameter and (b) an order of included query parameters, and where each of the plurality of received webpage requests includes at least one copy of each query parameter of each of all others of the plurality of received webpage requests, transmitting, for all of the plurality of received webpage requests, by a computer processor, and to a web server, a respective normalized webpage request, wherein all of the normalized webpage requests include an identical number of query parameters in an identical order.

10. A computer-implemented page link normalization method, comprising:
responsive to receipt of a webpage addressed to a receiving entity and including a webpage link, modifying, by a computer processor, the webpage by at least one of (a) removing one or more of duplicative parameters included in the link, and (b) changing an order of parameters of the link; and
forwarding, by the processor and to the receiving entity, the modified webpage.

11. A computer-implemented method for duplicate content connection, comprising:
comparing, by a computer processor, fingerprints, each associated with a different one of a plurality of page source identifiers;
for a subset of the plurality of page source identifiers for which it is determined in the comparing that the fingerprints of the subset are identical, recording, by the processor, a selection of one of the page source identifiers of the subset as authoritative; and
responsive to a page request using one of the subset of page source identifiers other than the one selected as authoritative, returning a page redirect with the page source identifier selected as authoritative.

12. The method of claim 11, wherein each of at least one of the plurality of page source identifiers is a Uniform Resource Locator (URL).

13. The method of claim 11, further comprising:
generating the fingerprints based on respective content obtainable by the respective page source identifiers.

14. The method of claim 13, wherein the content on which the fingerprints are based is limited to content that is displayed on a user interface in response to respective page requests.

15. The method of claim 11, wherein the fingerprints are checksum values.

16. The method of claim 11, further comprising:
determining which of the subset of page source identifiers is the shortest, wherein the shortest of the subset of page source identifiers is selected as the authoritative page source identifier.

17. The method of claim 11, further comprising:
determining which of the subset of page source identifiers is most frequently used in page requests, wherein the most frequently used of the subset of page source identifiers is selected as the authoritative page source identifier.

18. The method of claim 17, wherein the one of the subset of page source identifiers recorded as the authoritative page source identifier changes over time.

19. The method of claim 11, wherein the recordation is based on a user selection.

20. The method of claim. 11, wherein the selection is based on at least one of sizes of respective ones of the subset of page source identifiers and frequencies of use of the respective ones of the subset of page source identifiers.

21. A computer-implemented method for near-duplicate content correction, comprising:
determining, by a computer processor, that content associated with a subset of a plurality of page source identifiers is similar;
recording, by the processor, a selection of one of the page source identifiers of the subset as authoritative; and
providing, by the processor, a canonical tag to the authoritative page source identifier to each of the other page source identifiers of the subset.

22. The method of claim 21, wherein the canonical tags are inserted into respective hyper-text markup language (HTML) headers of respective pages associated with the respective other page source identifiers of the subset.

23. The method of claim 21, wherein respective ones of the canonical tags are provided to respective ones of the other page source identifiers in response to respective page requests using the respective ones of the other page source identifiers.

24. The method of claim 21, wherein the determination is based on a comparison of simhash values associated with the plurality of page source identifiers.

25. A computer-implemented page link optimization method, comprising:
responsive to receipt of a webpage addressed to a receiving entity and including a first webpage link:
determining, by a computer processor, that the first webpage link is part of a group of webpage links for which a second webpage link is recorded as being authoritative;
in accordance with the determination, modifying, by the processor, the webpage by replacing the first webpage link with the second webpage link; and
forwarding, by the processor and to the receiving entity, the modified webpage;
wherein the webpage links of the group are included in the group in response to a determination that content associated with the webpage links of the group are duplicative.

26. A computer-implemented page optimization method, comprising:
determining, by a computer processor, that a page source identifier includes one or more of a plurality of character strings that are each associated with a respective transformation rule set; and
in accordance with the determination, modifying, by the processor, content of a page identified by the page source identifier by application of each of the respective one or more transformation rule sets.

27. The method of claim 26, wherein, in response to a page request from a requesting entity, the modifying is performed and the modified page is provided to the requesting entity.

28. The method of claim 27, wherein the processor forwards the page request to a web server, obtains the page from the web server in response to the forwarded page request, and performs the modification to the page obtained from the web server in response to the forwarded request.
